(19) United States
(12) Patent Application Publication
(10) Pub. No.: US 2026/0348431 A1
(43) Pub. Date: Nov. 5, 2026

(54) ROLLING-BEARING ELEMENT AND METHOD FOR PRODUCING A ROLLING-BEARING ELEMENT

(71) Applicant: Schaeffler Technologies AG & Co. KG, Herzogenaurach (DE)

(72) Inventors: Wolfgang Braun, Garstadt (DE); Thomas Papke, Rückersdorf (DE); Michael Reith, Werneck (DE)

(21) Appl. No.: 18/997,560

(22) PCT Filed: Dec. 2, 2022
(86) PCT No.: PCT/DE2022/100905

§ 371 Date: Jan. 22, 2025

(30) Foreign Application Priority Data
Jul. 22, 2022 (DE) 10 2022 118 368.8

(51) Int. Cl. F16C 33/64; B33Y 80/00; F16C 33/62

(52) U.S. Cl. CPC F16C 33/64; F16C 33/62; B33Y 80/00

(57) ABSTRACT

A rolling-bearing element (1), in particular a bearing ring, has a multiplicity of 3D-printed layers (7, 11, 12), wherein at least a sub-quantity of these layers (7, 11, 12) is built up from a plurality of layer portions (8, 9, 10) which are arranged one beside the other in the relevant layer (7, 11, 12) and are made of different materials, and wherein identical layer portions (8, 9, 10) in a plurality of these layers (7, 11, 12) are arranged directly one above the other, and this results in material layering in a direction transverse to the build-up of the 3D-printed layers (7, 11, 12).

### CROSS-REFERENCE TO RELATED APPLICATION

The present application is the U.S. National Phase of PCT Patent Application Number PCT/DE2022/100905, filed on Dec. 2, 2022, which claims priority to German Patent Application Number 10 2022 118 368.8, filed Jul. 22, 2022, the entire disclosures of which are incorporated by reference herein.

### TECHNICAL FIELD

The disclosure relates to an additively manufactured rolling bearing element. The disclosure further relates to a method for producing such a rolling bearing element.

### BACKGROUND

A bearing component is known from WO 2012/022616 A1 which is manufactured by means of a 3D printing process. The production of a rolling bearing cage is described in detail in WO 2012/022616 A1. In addition, the possibility of additively manufacturing bearing rings is mentioned. In any case, it is provided to apply a thin, nanocrystalline coating to the base body of the bearing component. The nanocrystalline coating improves the mechanical strength and chemical resistance of the bearing component.

In DE 10 2017 115 803 A1, the possibility of deposition welding is discussed in connection with the production of bearing components. It is proposed to apply a layer of a heat-resistant material representing a second component portion to a component portion made of a high-temperature alloy by deposition welding, wherein a rolling element raceway is formed on the second layer. Overall, DE 10 2017 115 803 A1 concerns components of an aircraft engine.

Spraying processes that can be used in the manufacture of bearing components are disclosed in the documents DE 10 2012 203 110 A1 and DE 10 2006 023 690 A1. In both cases, the spraying of molten metal onto a tubular workpiece is provided.

Further possibilities for material application are described, for example, in WO 2019/185626 A1. In this case, a material pattern located on a base is transferred to a substrate.

### SUMMARY

The disclosure is based on the object of expanding the possibilities of using additive processes in the production of rolling bearing components compared to the aforementioned prior art, whereby a particularly favorable ratio between production effort and achievable product properties is sought.

According to the disclosure, this object is achieved by a rolling bearing element having the features of claim 1. The object is also achieved by a method for producing a rolling bearing element according to claim 9. The configurations and advantages of the disclosure explained below in connection with the production method also apply analogously to the device, i.e., the rolling bearing element, and vice versa.

The rolling bearing element has a plurality of 3D-printed layers, wherein at least a subset of these layers is built up from a plurality of layer portions which are arranged one beside the other in the relevant layer and are made of different materials. Within a layer stack from which the rolling bearing element is formed, identical layer portions in a plurality of the layers are arranged directly above one another, and this results in material layering in a direction transverse to the build-up of the 3D-printed layers.

Overall, this results in layers that are at least partially orthogonal to each other, i.e., in intersecting directions. On the one hand, these are the layers that are built up on top of each other during additive manufacturing. On the other hand, layering in the transverse direction is created by the fact that each individual 3D-printed layer is formed from several adjacent portions, wherein identical portions of a plurality of layers together result in a layer-like region that extends essentially orthogonally to the superimposed 3D-printed layers.

The overall structure of the rolling bearing element can thus be viewed as matrix-like in cross-section, although a strictly rectangular row-column pattern does not necessarily have to be present. Rather, the 3D-printed layers are to be understood as rows, whereas the so-called columns formed by identical layer portions do not necessarily have a uniform width or a course perpendicular to the rows. Nevertheless, in all cases there is an intersecting structure of the 3D-printed layers on the one hand and the different material layers on the other. It has been shown that this makes it possible to manufacture the rolling bearing element with acceptable effort and that the material properties in the different volume and surface areas can be excellently tailored to the respective requirements.

The rolling bearing element can generally be produced by additively producing a plurality of layers, in each of which different materials, which differ from one another at least with regard to their electrical conductivity, are arranged one beside the other in geometrically defined layer portions, wherein identical layer portions are produced directly one above the other in a plurality of the said layers in such a way that a material layering is created in a direction transverse to the build-up of the additively manufactured layers.

According to various possible embodiments, at least one of the layer portions is built up of a metallic material and another layer portion is built up of an electrically insulating material. The electrically insulating material may in particular contain at least one of the materials glass and ceramic in the form of a frit. A frit is an initially powdered material made of glass and/or ceramic, which, during additive manufacturing, forms a solid component under the influence of temperature, in this case a rolling bearing element. The thickness of the electrically insulating layer of the rolling bearing element, which can also be manufactured in other ways from glass, ceramic or glass ceramic, is 0.1 mm to 1 mm in typical designs.

A high-speed steel of grade 1.3344 (X 130 WMoCrV 6-5-4-3) is particularly suitable as a metallic material for the rolling bearing element for the functional area, i.e., the raceway, that can be processed using 3D printing methods.

Workpieces made of steel with the material number 1.3344 can be manufactured using powder metallurgy, among other things, and are characterized by a homogeneous material structure, which has a tough material matrix and very high contents of fine, evenly distributed carbides. Stable properties are maintained up to extremely high application temperatures of 400 °C.

In this case, surface hardnesses of 60 HRC and above can be achieved using steel of grade 1.3344 PM without subsequent heat treatment. In a typical method, the rolling bearing element is finished after additive manufacturing only by grinding and/or honing, i.e., machining with a geometrically undefined cutting edge.

In central volume regions of the rolling bearing element between an electrically insulating layer forming a first workpiece surface on the one hand and a metallic layer made of a highly resilient material on the other hand, there can be a further metallic layer which is made of a comparatively low-resilience metallic material.

The rolling bearing element can be, for example, a rolling element or a bearing ring. Special forms of rolling elements, for example planets of planetary roller screw drives, can also be produced by the process according to the application.

If the rolling bearing element is designed as the inner ring of a rolling bearing, the diameter of the bore of the bearing ring can, for example, be in the range of 5 mm to 70 mm or even more. In all cases, one advantage of the manufacturing process is that an electrical insulating layer, including on the bore of the ring-shaped workpiece, can be produced in a single manufacturing step, i.e., during the additive manufacturing of the rolling bearing element.

The inner ring bore is a relatively small area compared to other surfaces of the rolling bearing. The electrical insulation at this point thus minimizes capacitances compared to spatially more extensive insulating layers, such as on the outer circumferential surface of an outer ring, so that the transmission of alternating currents is minimized. If the bearing ring has at least one rim, an insulating layer can be located, for example, on one of the rims or on both rims, or on neither rim.

In all cases in which a rolling element raceway is formed by a metallic component of the rolling bearing element, in a region of layers providing the rolling element raceway, each layer of this region can be built up from three different layer portions arranged one beside the other, namely a metallic raceway portion, a central, likewise metallic layer portion and an insulating portion, whereas in a region of layers spaced apart from the rolling element raceway, each layer is built up from only two different layer portions, namely an insulating portion and a portion whose composition corresponds to the central layer portions.

The thickness of the material layer providing the rolling element raceway is not necessarily uniform. For example, the thickness of the layer portions providing the rolling element raceway, measured in the normal direction of a plane tangent to the rolling element raceway, decreases outwards from the center of the rolling element raceway. At the same time, both a cylindrical surface and an end face surface of the rolling bearing element can be formed by the electrically insulating layer portions.

In general, the material layer that serves as the rolling element raceway is also referred to as the functional layer. In various possible designs, the material thickness of the functional layer is in the range of 0.3 mm to 5 mm depending on the bearing size, which corresponds, for example, to 2% to 10%, in particular about 5%, of the rolling element diameter assigned to the bearing.

The additive manufacturing of the rolling bearing element also has the advantage that cooling and/or lubrication channels that run through the rolling bearing element can be produced during the manufacturing process. In the same way, cavities can be created to minimize the mass of the rolling bearing element and thus also the moments of inertia relevant to the operation of the rolling bearing. In addition, it is possible, among other things, to prepare a seal seat of suitable material properties so that machining steps can be eliminated.

The thermal expansion coefficients of the various materials, some metallic and some non-metallic, from which the rolling bearing element is additively constructed must be coordinated with one another, whereby matching expansion coefficients are ideal. The heating of the various materials, which are typically in powder form, is usually performed using a laser. Laser processing not only solidifies the individual material layers, but also creates strong connections between the different material portions. In order to make the connections between the different materials even more resilient, interlocking geometries can be provided between the individual layer portions.

The rolling bearing element is particularly suitable for use under conditions that generally increase wear. Key words in this context include thin oils, long grease usage times and high speeds. In addition, the rolling bearing element is particularly suitable for use in electrical machines, as the passage of current is prevented by means of the insulating non-metallic layer. The rolling bearing comprising the rolling bearing element can be a bearing of any known type, for example a ball bearing, cylindrical roller bearing, barrel roller bearing or tapered roller bearing.

### BRIEF DESCRIPTION OF THE DRAWINGS

In the following, an exemplary embodiment of the disclosure is explained in more detail with reference to drawings. In the figures:

FIG. 1 shows a rolling bearing, namely a single-row angular contact ball bearing, in a sectional view,

FIG. 2 shows an additively produced inner ring of the rolling bearing according to FIG. 1,

FIG. 3 shows a schematic representation of a layer structure of the inner ring.

### DETAILED DESCRIPTION

A rolling bearing, designated overall with 1, is designed as an angular contact ball bearing in the exemplary embodiment. The ball bearing 1 comprises an inner ring 2, a number of rolling elements 3, i.e., balls, which are optionally guided in a cage (not shown), and an outer ring 4. The bearing rings 2, 4 and rolling elements 3 are collectively referred to as rolling bearing elements 2, 3, 4. The rolling elements 3 roll on a raceway 5 of the inner ring 2 and a raceway 6 of the outer ring 4. In the following, the inner ring 2 is examined in more detail, whereby the outer ring 4 can be manufactured in the same or any other way. The bore of the inner ring 2 is designated with 13 and has a cylindrical wall 14, whereby the wall 14 can also have a slightly conical shape. Overall, the rolling bearing 1 is suitable for absorbing radial and axial forces in one direction in any known manner.

The inner ring 2 has on its outer side, i.e., its side providing the raceway 5, a partially curved contour which is designed according to the desired pressure angle of the ball bearing 1.

The entire inner ring 2 is additively manufactured, which is printed in a build-up of individual layers 7, 11. Each layer 7, 11 is made from different powdered starting materials that are heated by a laser during additive manufacturing. In the portion of the inner ring 2 in which the raceway 5 is formed, each layer 7 is composed of three mutually distinguishable portions 8, 9, 10. In detail, this is an insulating portion 8, which forms the cylindrical wall 14, a central layer portion 9 made of a metallic material and a likewise metallic portion 10, which forms the raceway 5.

The raceway portion 10 is made of high speed steel of grade 1.3344 and has a surface hardness of at least 60 HRC. In comparison, the hardness of the central layer portion 9 is lower. The central layer portion 9 provides a slight but technically relevant ductility of the inner ring 2. Overall, the layer portions 8, 9, 10 represent material layers which are aligned essentially transversely to the layers 7, 11 arranged horizontally in the figures.

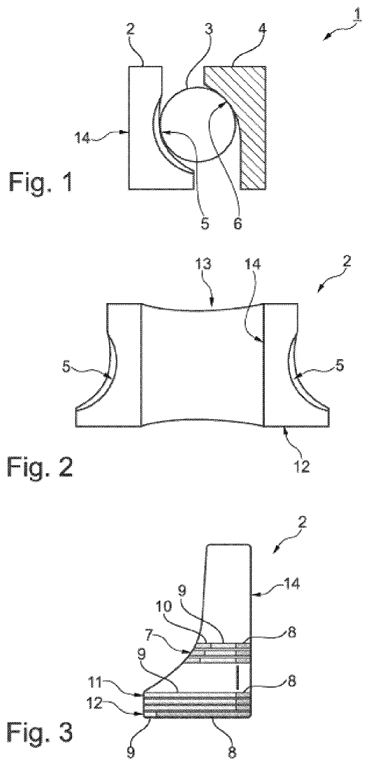

As indicated in FIGS. 1 and 2, the thickness of the raceway layer 10, measured in the radial direction of the rolling bearing 1, is non-uniform within the raceway layer 10. The greatest thickness of the raceway layer 10 is present at the point where the mechanical load from the rolling element 3 is maximum, i.e., in the area through which the pressure line runs. An inclined pressure line, as in the present case, means that the rolling bearing 1 is able to absorb both radial and axial forces. In the direction of the edges of the raceway 5, i.e., in the direction of a lower mechanical load on the raceway 5, the thickness of the raceway portion 10 decreases. Outside the raceway 5, the raceway portion 10 is completely omitted, as shown in FIG. 3. In this area there are layers designated with 11, which are formed only from the layer portions 8, 9. Irrespective of the fact that the layer portion 9 in this case extends to the surface of the inner ring 2, it is consistently referred to as a central layer portion 9. A special feature is provided in the end face layer designated with 12: In this case, the insulating portion 8 extends over almost the entire layer 12, so that the desired electrical insulating effect is provided not only on the cylindrical wall 14, but also on almost the entire end face of the inner ring 2. Deviating from the structure shown schematically in FIG. 3, a complete formation of the end face layer 12 as an insulating layer 8 is also possible.

### LIST OF REFERENCE SIGNS

1 Rolling bearing, ball bearing
2 Inner ring
3 Rolling element, ball
4 Outer ring
5 Inner ring raceway
6 Outer ring raceway
7 Layer of the first type, built up of three layer portions
8 Insulating portion of the layer
9 Central layer portion
10 Raceway portion of the layer
11 Layer of the second type, built up of two layer portions
12 End face layer
13 Bore of the inner ring
14 Wall of the bore

1. A rolling bearing element having a plurality of 3D-printed layers, wherein at least a subset of these layers is built up from multiple layer portions which are arranged one beside the another in the respective layer and are made of different materials, and wherein identical layer portions in a plurality of these layers are arranged directly one above the other causing material layering in a direction transverse to the build-up of the 3D-printed layers.

2. The rolling bearing element according to claim 1, wherein at least one of the layer portions is made of a metallic material and a further layer portion is made of an electrically insulating material.

3. The rolling bearing element according to claim 2, wherein the electrically insulating material contains at least one of the materials glass and ceramic in the form of a frit.

4. The rolling bearing element according to claim 2, wherein steel with the material number 1.3344 is provided as the metallic material of at least one layer portion.

5. The rolling bearing element according to claim 2, wherein a rolling element raceway is formed by a plurality of metallic layer portions layered one above the other.

6. The rolling bearing element according to claim 3, wherein, in a region of layers providing the rolling element raceway, each layer is built up from three different layer portions arranged one beside the other, namely a metallic raceway portion, a central metallic layer portion and an insulating portion, wherein in a region of layers spaced apart from the rolling element raceway, each layer is built up from only two different layer portions including an insulating portion and a portion whose composition corresponds to the central layer portions.

7. The rolling bearing element according to claim 6, wherein the rolling bearing element is configured as a bearing ring.

8. The rolling bearing element according to claim 7, wherein the thickness of the layer portions providing the rolling element raceway, measured in the normal direction of a plane tangent to the rolling element raceway, decreases outwards from the center of the rolling element raceway and both a cylindrical surface and an end face surface are formed by the electrically insulating layer portions.

9. A method for producing a rolling bearing element comprising: additively producing a plurality of 3D-printed layers, in each of which different materials, which differ from one another at least with regard to their electrical conductivity, are arranged one beside the other in geometrically defined layer portions, wherein identical layer portions are produced directly one above the other in a plurality of the said layers in such a way that a material layering is created in a direction transverse to the build-up of the additively manufactured layers, wherein at least a subset of the 3-D printed layers is built up from multiple layer portions arranged one beside another in the respective layer and are made of different materials, and wherein identical layer portions in a plurality of the layers are arranged directly one above the other causing material layering in a direction transverse to the build-up of the 3D-printed layers.

10. The method according to claim 9, further comprising: finishing a surface of the rolling bearing element by machining with a geometrically undefined cutting edge.

11. A rolling bearing element comprising:
a plurality of 3D-printed layers, wherein at least a subset of the 3-D printed layers is built up from multiple layer portions arranged one beside another in the respective layer and are made of different materials, and wherein identical layer portions in a plurality of these layers are arranged directly one above the other causing material layering in a direction transverse to the build-up of the 3D-printed layers,
wherein at least one of the layer portions is made of a metallic material and a further layer portion is made of an electrically insulating material,
wherein the electrically insulating material contains at least one of the materials glass and ceramic in the form of a frit,
wherein, in a region of layers forming a rolling element raceway, each layer is built up from three different layer portions arranged one beside the other, wherein the three different layer portions comprise a metallic raceway portion, a central metallic layer portion and an insulating portion, wherein in a region of layers spaced apart from the rolling element raceway, each layer is built up from only two different layer portions comprising an insulating portion and a portion whose composition corresponds to the central layer portions.

12. The rolling bearing element according to claim 11, wherein the metallic material comprises steel with the material number 1.3344.

13. The rolling bearing element according to claim 11, wherein the rolling element raceway is formed by a plurality of metallic layer portions layered one above the other.

14. The rolling bearing element according to claim 11, wherein the rolling bearing element is configured as a bearing ring.

15. The rolling bearing element according to claim 14, wherein the thickness of the layer portions providing the rolling element raceway, measured in the normal direction of a plane tangent to the rolling element raceway, decreases outwards from the center of the rolling element raceway and both a cylindrical surface and an end face surface are formed by the electrically insulating layer portions.
